(19) United States
(12) Patent Application Publication
(10) Pub. No.: US 2026/0365264 A1
(43) Pub. Date: Nov. 19, 2026

(54) ROBOT JOINT STRUCTURE AND ROBOT

(71) Applicant: KAWASAKI JUKOGYO KABUSHIKI KAISHA, Kobe-shi, Hyogo (JP)

(72) Inventors: So YUKIZAKI, Kobe-shi (JP); Junichi KARASUYAMA, Kobe-shi (JP); Masayuki KAMON, Kobe-shi (JP)

(73) Assignee: KAWASAKI JUKOGYO KABUSHIKI KAISHA, Kobe-shi, Hyogo (JP)

(21) Appl. No.: 19/144,247

(22) PCT Filed: Dec. 28, 2023
(86) PCT No.: PCT/JP2023/047243

§ 371 Date: Jun. 27, 2025

(30) Foreign Application Priority Data
Dec. 28, 2022 (JP) 2022-211650

(51) Int. Cl. B62D 57/032; H02K 7/06; H02K 7/10; H02K 11/21

(52) U.S. Cl. CPC B62D 57/032; H02K 7/06; H02K 7/1004; H02K 11/21

(57) ABSTRACT

A robot joint structure includes a driving-force transmitter including a rotating shaft that is rotated by rotational drive of a first electric motor and a second electric motor. The driving-force transmitter rotates the first link and the second link relative to each other in response to rotation of the rotating shaft. In addition, the robot joint structure includes a first belt that transmits rotational drive from the first electric motor to the rotating shaft, and a second belt that transmits rotational drive from the second electric motor to the rotating shaft.

### TECHNICAL FIELD

The present disclosure relates to a robot joint structure and a robot, in particular to a robot joint structure and a robot including electric motors as driving sources.

### BACKGROUND ART

Robot joint structures including electric motors as driving sources are known in the art. For example, the above Japanese Patent Laid-Open Publication No. JP 2019-076992 discloses hip joint structures in a bipedal mobile robot using first electric motors and second electric motors, which drive links. In the hip joint structures, open/close links, which are the leg-side components, are rotated relative to swivel links, which are waist-side components in the bipedal robot, by the first electric motors and the second electric motors as driving sources. Specifically, the hip joint structure of the above Japanese Patent Laid-Open Publication No. JP 2019-076992 includes first driving wheels, second driving wheels, rolling wheels, and driven wheels. The first driving wheels and the second driving wheels are connected to their respective output shafts of the first electric motors and the second electric motors. Endless belts are wound around the first drive wheels, the second drive wheels, the rolling wheels, and the driven wheels. The second electric motors follow rotation of the first electric motors so that driving force of the first electric motors and the second electric motors are transmitted to the driven wheels via the endless belts.

The leg-side open/close links are rotated relative to the waist-side swivel links by driving force transmitted to the driven wheels. Here, the first drive wheels, the rolling wheels and the driven wheels are arranged on the inner sides of the endless belts, and the second drive wheels are arranged on the outer sides of the endless belts. In other words, both the inner sides and the outer sides of the endless belts are used to transmit driving force.

### PRIOR ART

### Patent Document

Patent Document 1: Japanese Patent Laid-Open JP 2019-076992

### SUMMARY OF THE INVENTION

However, when both the inner and outer sides of an endless belt are used to transmit driving force from electric motors as in the joint structure of the robot disclosed in the above Japanese Patent Laid-Open Publication No. JP 2019-076992, the belt must have teeth or contact surfaces transmitting driving force on its both sides. Since typical belts do not have teeth or contact surfaces on both sides, it is desired to use electric motors as driving sources without requiring both sides of a belt to transmit driving force.

The present disclosure is intended to solve the above problem, and one object of the present disclosure is to provide a robot joint structure and a robot capable of using electric motors as driving sources without requiring both sides of a belt to transmit driving force.

A robot joint structure according to a first aspect of the present disclosure includes a first link and a second link that are connected to each other via a joint; a first electric motor and a second electric motor that serve as driving sources to rotate the first link and the second link relative to each other; a driving-force transmitter that includes a rotating shaft rotated by rotational drive from the first electric motor and the second electric motor, and that rotates the first link and the second link relative to each other in response to rotation of the rotating shaft; a first belt that transmits rotational drive from the first electric motor to the rotating shaft; and a second belt that transmits rotational drive from the second electric motor to the rotating shaft.

In the robot joint structure according to the first aspect of the present disclosure, as discussed above, a first belt that transmits rotational drive from the first electric motor to the rotating shaft; and a second belt that transmits rotational drive from the second electric motor to the rotating shaft are provided. Accordingly, driving force can be transmitted by using only one side of each of the first belt and the second belt even when the electric motors, which are the first electric motor and the second electric motor, are used as driving sources.

Consequently, it is possible to use electric motors as driving sources without requiring both sides of a belt to transmit driving force.

A robot according to a second aspect of the present disclosure includes a first link and a second link that are connected to each other via a joint; a first electric motor and a second electric motor that serve as driving sources to rotate the first link and the second link relative to each other; a driving-force transmitter that includes a rotating shaft rotated by rotational drive from the first electric motor and the second electric motor, and that rotates the first link and the second link relative to each other in response to rotation of the rotating shaft; a first belt that transmits rotational drive from the first electric motor to the rotating shaft; and a second belt that transmits rotational drive from the second electric motor to the rotating shaft.

In the robot according to the second aspect of the present disclosure, as discussed above, a first belt that transmits rotational drive from the first electric motor to the rotating shaft; and a second belt that transmits rotational drive from the second electric motor to the rotating shaft are provided. Accordingly, driving force can be transmitted by using only one side of each of the first belt and the second belt even when the electric motors, which are the first electric motor and the second electric motor, are used as driving sources. Consequently, it is possible to provide a robot capable of using electric motors as driving sources without requiring both sides of a belt to transmit driving force.

According to the present disclosure, it is possible to use electric motors as driving sources without requiring both sides of a belt to transmit driving force.

### BRIEF DESCRIPTION OF THE DRAWINGS

FIG. 1 is a perspective view showing a humanoid robot according to one embodiment of the present disclosure.

FIG. 2 is a block diagram showing the overall configuration of robot joint structure in the humanoid robot.

FIG. 3 is a perspective view schematically showing the configuration of a joint and a linear movement mechanism.

FIG. 4 is a side view illustrating the configuration of the joint.

FIG. 5 is a schematic perspective view illustrating an arrangement of a first electric motor and a second electric motor.

FIG. 6 is a schematic front view illustrating an arrangement of a first belt and a second belt.

FIG. 7 is a schematic top view illustrating the arrangement of the first belt and the second belt with respect to a thigh link.

FIG. 8 is a side view illustrating a robot joint structure according to a modified example of the one embodiment of the present disclosure.

### MODES FOR CARRYING OUT THE INVENTION

The following description will describe one embodiment embodying the present disclosure with reference to the drawings.

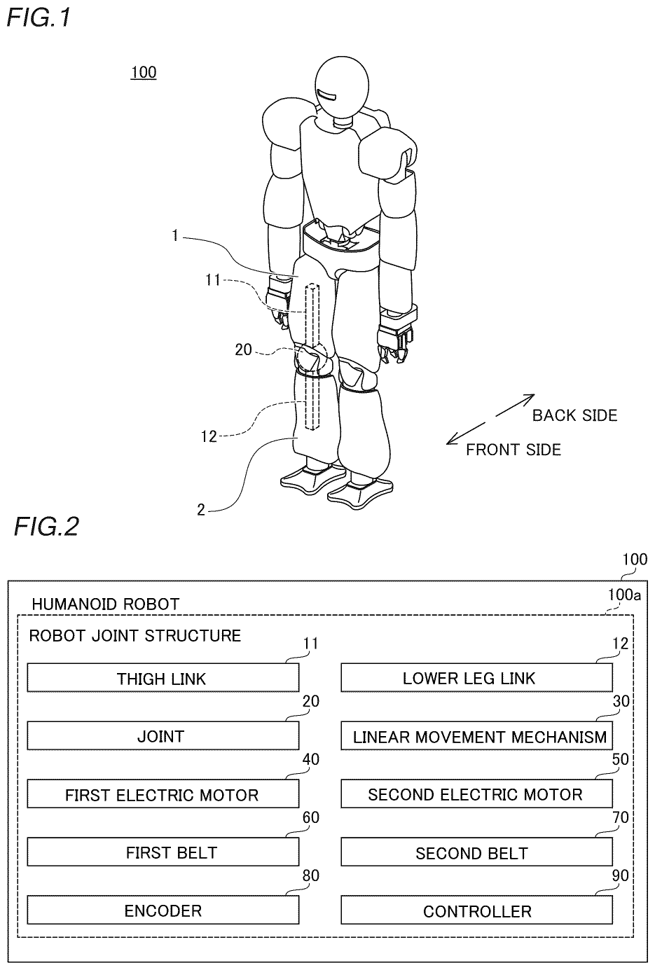

The following description describes a configuration of a humanoid robot 100 according to an embodiment with reference to FIGS. 1 to 7. The humanoid robot 100 is also referred to as a humanoid. Here, the humanoid robot 100 is an example of a robot.

As shown in FIG. 1, the humanoid robot 100 includes a pair of thighs 1 and a pair of lower legs 2, corresponding to those of a human. The thigh 1 corresponds to a thigh of a human. The lower leg 2 corresponds to a lower leg of a human. Here, the pair of thighs 1 have similar structures, and the pair of lower legs 2 also have similar structures; accordingly, the following description will describe the thigh 1 and the lower leg 2 of only one leg.

The humanoid robot 100 includes a thigh link 11 and a lower leg link 12. The thigh link 11 and the lower leg link 12 are rod-shaped parts in a certain portion of the humanoid robot 100. Specifically, the thigh link 11 is a component of the thigh 1 in the humanoid robot 100. The lower leg link 12 is a component of the lower leg 2 in the humanoid robot 100. The thigh link 11 and the lower leg link 12 include metal components such as aluminum or stainless steel, for example. Here, the thigh link 11 is an example of a first link. The lower leg link 12 is an example of a second link.

Also, the thigh link 11 and the lower leg links 12 are connected to each other via a joint 20. The joint 20 is a knee joint in the humanoid robot 100. The thigh link 11 and the lower leg link 12 rotate relative to each other when the joint 20 rotates. Specifically, the thigh link 11 and the lower leg link 12 rotate relative to each other to perform bending and stretching motions. The relative rotation of the thigh link 11 and the lower leg link 12 allows the humanoid robot 100 to walk on two legs.

As shown in FIG. 2, the humanoid robot 100 includes a robot joint structure 100a. The robot joint structure 100a according to this embodiment includes the thigh link 11, the lower leg link 12, and the joint 20. The robot joint structure 100a includes a linear movement mechanism 30, a first electric motor 40, a second electric motor 50, a first belt 60, a second belt 70, an encoder 80 and a controller 90 that are configured to drive the thigh link 11, the lower leg link 12 and the joint 20. Here, the linear movement mechanism 30 is an example of a driving-force transmitter.

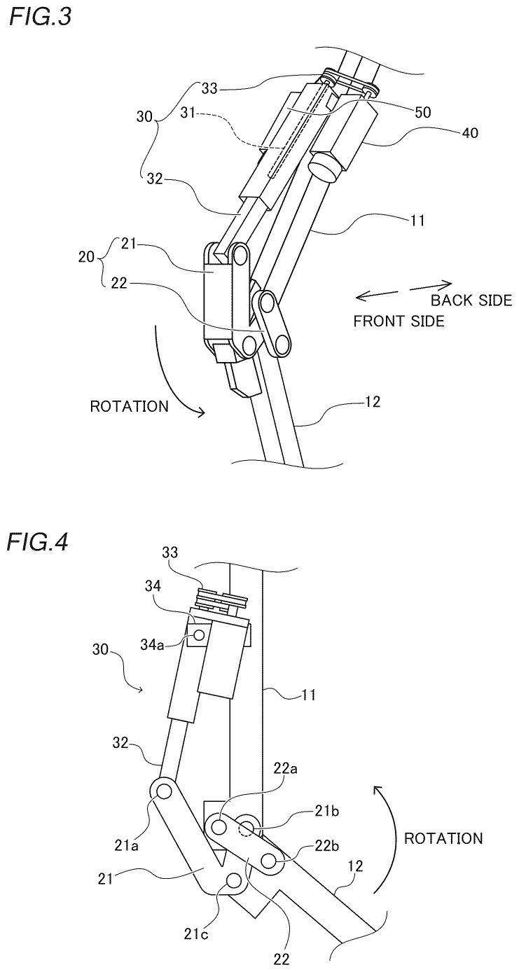

As shown in FIG. 3, the linear movement mechanism 30 includes a rotating shaft 31, a linear movement outputter 32 and a pulley 33. For example, the linear movement mechanism 30 includes a ball-screw mechanism. The rotating shaft 31 is rotated by rotational drive of the first electric motor 40 and the second electric motor 50. The linear movement outputter 32 moves linearly in response to rotation of the rotating shaft 31. The pulley 33 rotates when rotational drive of the first electric motor 40 and the second electric motor 50 is transmitted. Specifically, the pulley 33 is connected to the rotating shaft 31 and rotates together with the rotating shaft 31. The rotating shaft 31 is, for example, a rod-shaped part having threads and is arranged inside the linear movement outputter 32. The linear movement outputter 32 is a rod-shaped part, and has a nut that is located inside the outputter and threadedly engages with the rotating shaft 31. In the linear movement mechanism 30, the rod-shaped linear movement outputter 32 moves linearly in a longitudinal direction in response to rotation of the rotating shaft 31, which rotates together with the pulley 33. In other words, in the linear movement mechanism 30, the linear movement outputter 32 moves linearly in the longitudinal direction in response to rotation of the first electric motor 40 and the second electric motor 50.

In the linear movement mechanism 30, an end of the linear movement outputter 32 is rotatably connected to the joint 20. Also, the linear movement mechanism 30 is arranged rotatably relative to the thigh link 11. The linear movement mechanism 30 rotates the joint 20 by moving linearly. The linear movement mechanism 30 rotates the thigh link 11 and the lower leg link 12 relative to each other in response to rotation of the rotating shaft 31. In other words, the linear movement mechanism 30 rotates the joint 20 to rotate the thigh link 11 and the lower leg link 12 relative to each other as the linear movement outputter 32 moved linearly. In other words, the linear movement mechanism 30 is a driving force transmission mechanism that transfers driving force of rotation from the first electric motor 40 and the second electric motor 50 to rotate the thigh link 11 and the lower leg link 12 relative to each other. The rotating shaft 31 of the linear movement mechanism 30 is arranged along the rod-shaped thigh link 11, which is a component of the thigh 1, to rotate the joint 20, which is the knee joint. Also, the linear movement mechanism 30 is arranged on a side opposite to a direction of rotation in which the thigh link 11 and the lower leg link 12 are rotated relative to each other to perform a bending motion. In other words, the linear movement mechanism 30 is arranged on a front side of the thigh 1 in the humanoid robot 100.

The joint 20 includes two links 21 and 22. The links 21 and 22 are arranged to intersect each other when the thigh link 11 and the lower leg link 12 are in a stretched state. Each of the links 21 and 22 connects the thigh link 11 and the lower leg link 12 to each other.

Also, the link 21 is connected to an end of the linear movement outputter 32 of the linear movement mechanism 30. The link 21 has a V shape as viewed from a lateral side, which is a left/right-direction side of the humanoid robot 100.

As shown in FIG. 4, specifically, the link 21 is rotatably connected to the end of the linear movement outputter 32 of the linear movement mechanism 30 via a connector 21a. Also, the link 21 is rotatably connected to the thigh link 11 via a connector 21b. The link 21 is rotatably connected to the lower leg link 12 via a connector 21c. Similarly, the link 22 is rotatably connected to the thigh link 11 via a connector 22a. The link 22 is rotatably connected to the lower leg link 12 via a connector 22b. Both the links 21 and 22 are arranged on both sides of the thigh link 11 and the lower leg link 12 in the left/right direction to interpose the thigh link and the lower leg link between the links 21 and 22 to connect the thigh link and the lower leg link to each other. Also, each of an end of the thigh link 11 on the lower leg link 12 side and an end of the lower leg link 12 on the thigh link 11 side has an L shape. Also, the connector 21b and the connector 22a are arranged on the L-shaped end of the lower leg link 12 side of the thigh link 11. Similarly, the connector 21c and the connector 22b are arranged on the L-shaped end of the thigh link 11 side of the lower leg link 12.

Also, the pulley 33 side of the linear movement mechanism 30 is connected to the thigh link 11 via a support 34. The linear movement mechanism 30 is arranged rotatably about the rotation axis 34a relative to the thigh link 11. In the joint structure of the linear movement mechanism 30, the thigh link 11, the lower leg link 12, the link 21 and the link 22, the link 21 is rotated in response to linear translation of the linear movement outputter 32 of the linear movement mechanism 30. As the link 21 rotates, the lower leg link 12, which is connected to the connector 21c, rotates relative to the thigh link 11 while being constrained by the link 22. In other words, the lower leg link 12 is rotated relative to the thigh link 11 by the movement of the link 21 while its orientation is changed by its connection to the link 22.

### <Configuration of Electric Motors and Belts>

As shown in FIG. 5, the first electric motor 40 includes a first electric-motor rotation shaft 41 and a pulley 42. The second electric motor 50 includes a second electric-motor rotation shaft 51 and a pulley 52. In this embodiment, the first electric motor 40 and the second electric motor 50 are provided separately from each other. In the first electric motor 40, the pulley 42 is connected to the first electric-motor rotation shaft 41 and rotates together with the first electric-motor rotation shaft 41. In the second electric motor 50, the pulley 52 is connected to the second electric-motor rotation shaft 51 and rotates together with the second electric-motor rotation shaft 51. The first electric-motor rotation shaft 41 and the second electric-motor rotation shaft 51 Serve as rotation shafts of the first electric motor 40 and the second electric motor 50, respectively. The first electric motor 40 and the second electric motor 50 are servo motors that rotate based on feedback control from the controller 90. Accordingly, the first electric motor 40 and the second electric motor 50 serve as driving sources to rotate the thigh links 11 and the lower leg links 12 relative to each other. Also, the first electric motor 40 and the second electric motor 50 are arranged such that their rotation shafts extend along the rod-shaped thigh link 11. The first electric-motor rotation shaft 41 and the second electric-motor rotation shaft 51 are orientated substantially parallel to the rotating shaft 31 of the linear movement mechanism 30. Here, the first electric motor 40 and the second electric motor 50 rotate relative the thigh link 11 together with the linear movement mechanism 30. Specifically, the first electric motor 40 and the second electric motor 50 and the linear movement mechanism 30 are arranged on a fixed component 35 shared by the first and second electric motors.

The encoder 80 detects a rotational speed of the first electric motor 40. The encoder 80 outputs detection signals indicating rotational speeds of the first electric motor 40 to the controller 90. The encoder 80 is arranged on the first electric motor 40, for example. The encoder 80 detects a rotational speed of the first electric motor 40, for example, by detecting changes in the magnetic field in response to rotation.

The controller 90 controls rotational drive of the first electric motor 40 based on the detection signals from the encoder 80. The controller 90 outputs control signals to control rotation drive of the first electric motor 40 to an electric-motor driver (not shown) using feedback control based on the detection signals from the encoder 80, for example. The control signals are pulse signals, for example. The current supplied to the first electric motor 40 is controlled by these control signals. In this embodiment, the controller 90 drives the second electric motor 50 to follow the first electric motor 40 by controlling the rotational drive of both the first electric motor 40 and the second electric motor 50 using the control signals for the first electric motor 40. In other words, the controller 90 controls the rotation of the second electric motor 50 to synchronize with the rotation of the first electric motor 40. The first electric motor 40 and the second electric motor 50 are controlled to rotate at the same timing, in the same rotation direction and at the same rotational speed. The controller 90 is provided, for example, in a torso of the humanoid robot 100. Also, the controller 90 is a computer that includes a computing device, such as a CPU (Central Processing Unit) or an FPGA (Field-Programmable Gate Array), and a storage device, such as flash memory.

The first belt 60 transmits the rotational drive from the first electric motor 40 to the rotating shaft 31. The second belt 70 transmits the rotational drive from the second electric motor 50 to the rotating shaft 31. The first belt 60 and the second belt 70 are provided separately from each other. The first belt 60 is wound around the pulley 42 of the first electric motor 40 and the pulley 33 of the linear movement mechanism 30. The second belt 70 is wound around the pulley 52 of the second electric motor 50 and the pulley 33 of the linear movement mechanism 30. In other words, the first belt 60 transmits the rotation of pulley 42 of the first electric motor 40 to the pulley 33 of the linear movement mechanism 30. The second belt 70 transmits the rotation of pulley 52 of the second electric motor 50 to the pulley 33 of the linear movement mechanism 30. Also, the pulley 33, the pulley 42, and the pulley 52 are toothed pulleys. The first belt 60 and the second belt 70 have teeth on the inside. In contrast, the first belt 60 and the second belt 70 have no teeth on the outside. Here, the pulley 33 has a smaller outer diameter and fewer teeth than that of the pulley 42 and the pulley 52. Accordingly, the rotational speed of the pulley 33 is greater than the pulley 42 and the pulley 52. Here, the first belt 60 is not wound around any idler pulley or the like to adjust tension of the belt or a direction of travel. Similarly, the second belt 70 is not wound around any idler pulley or the like to adjust the tension of the belt or the direction of travel.

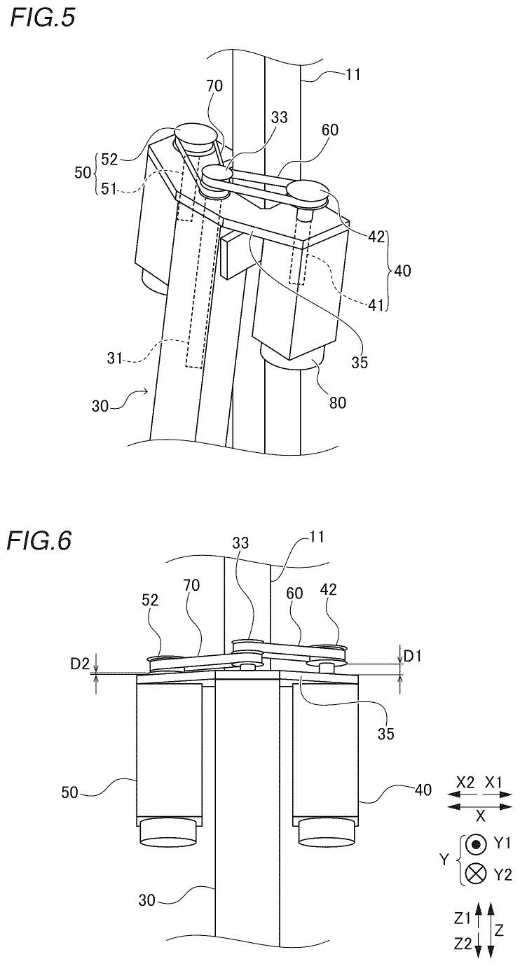

As shown in FIG. 6, the pulley 42 is arranged on a Z1-direction side, which is the upper side, of a body of the first electric motor 40. Also, the pulley 52 is arranged on the Z1-direction side, which is the upper side, of the body of the second electric motor 50. That is, all the pulley 33, the pulley 42 and the pulley 52 are arranged on the Z1-direction side. In this embodiment, the first belt 60 and the second belt 70 are positioned adjacent to each other and wound around the pulley 33, with an offset relative to each other in an extension direction of the rotating shaft 31, which is a Z direction. Specifically, the first belt 60 is positioned on an end side of the rotating shaft 31 as the upper side, which is the Z1-direction side, with respect to the second belt 70. Since the first belt 60 is positioned on the upper side, which is the Z1-direction side, with respect to the second belt 70, a distance D1 between the pulley 42 and the fixed component 35 is greater than a distance D2 between the pulley 52 and the fixed component 35.

Here, the first electric motor 40 and the second electric motor 50 are arranged on one side and another side of the thigh link 11 in a shorter widthwise direction, respectively, as viewed from a side where the rotating shaft 31 is positioned with respect to the rod-shaped thigh link 11. In other words, the first electric motor 40 is positioned on the X1-direction side with respect to the thigh links 11, as viewed from a Y1-direction side, which is the front side of the humanoid robot 100 when the thigh link 11 and the lower leg link 12 are in a stretched state. Also, the second electric motor 50 is positioned on the X2-direction side with respect to the thigh links 11, as viewed from the front side of the humanoid robot 100 when the thigh link 11 and the lower leg link 12 are in a stretched state. In other words, the thigh link 11 is interposed between the first electric motor 40 and the second electric motor 50 as viewed from the Y1-direction side. Here, the X1-direction side and the X2-direction side are examples of the one side and the another side of the shorter widthwise direction, respectively.

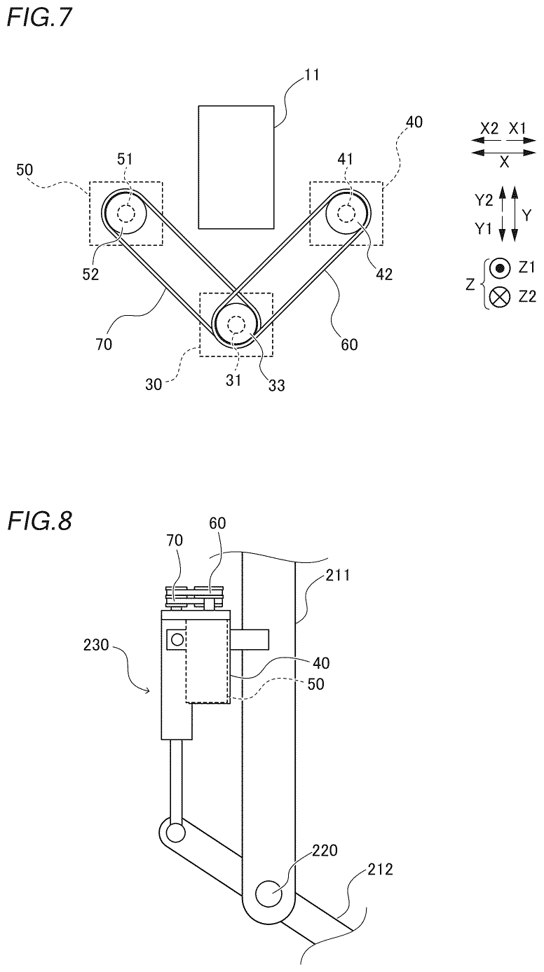

As shown in FIG. 7, the first electric motor 40 is arranged on the X1-direction side such that the first electric-motor rotation shaft 41 is positioned on the thigh link 11 side with respect to the rotating shaft 31 of the linear movement mechanism 30. Also, the second electric motor 50 is arranged on the X2-direction side such that the second electric-motor rotation shaft 51 is positioned on the thigh link 11 side with respect to the rotating shaft 31 of the linear movement mechanism 30. In other words, the first electric-motor rotation shaft 41 of the first electric motor 40 and the second electric-motor rotation shaft 51 of the second electric motor 50 are positioned on a Y2-direction side, which is a back side of the humanoid robot 100 when the thigh link 11 and the lower leg link 12 are in a stretched state, with respect to the rotating shaft 31 of the linear movement mechanism 30. Here, the positions of the first electric motor 40 and the second electric motor 50 in the Y direction are substantially equal to each other. In the robot joint structure 100a of the humanoid robot 100, the first electric motor 40 and the second electric motor 50 are arranged such that the first belt 60 and the second belt 70 form a V shape when viewed in the Z direction, which is the longitudinal direction of the rod-shaped thigh link 11.

### [advantages of the Embodiment]

In this embodiment, as described above, the robot joint structure 100a of the humanoid robot 100 as a robot includes the first belt 60 transmitting the rotational drive from the first electric motor 40 to the rotating shaft 31, and the second belt 70 transmitting the rotational drive from the second electric motor 50 to the rotating shaft 31. Accordingly, driving force can be transmitted by using only one side of each of the first belt 60 and the second belt 70 even when the electric motors, which are the first electric motor 40 and the second electric motor 50, are used as driving sources.

Consequently, it is possible to use electric motors as driving sources without requiring both sides of a belt to transmit driving force.

Also, in the robot joint structure 100a of the humanoid robot 100 as a robot according to this embodiment, as described above, the linear movement mechanism 30 includes the rotating shaft 31 and the linear movement outputter 32 moving linearly in response to rotation of the rotating shaft 31, and moves the thigh link 11 as the first link and the lower leg link 12 as the second link relative to each other by moving the linear movement outputter 32 linearly. The thigh link 11 and the lower leg link 12 are rod-shaped parts in a certain portion of the humanoid robot 100. The rotating shaft 31 of the linear movement mechanism 30 as the driving-force transmitter is arranged along the rod-shaped thigh link 11. The first electric motor 40 and the second electric motor 50 are arranged such that their rotation shafts extend along the rod-shaped thigh link 11. Accordingly, even when electric motors, which are the first electric motor 40 and the second electric motor 50, are used as the driving sources to rotate the rod-shaped thigh link 11 and the rod-shaped lower leg links 12 in the humanoid robot 100 relative to each other, the electric motors can be used as the driving sources without requiring both sides of each of the first belt 60 and the second belt 70 to transmit driving force. Also, the rotating shaft 31 of the linear movement mechanism 30, and the rotation shafts of the first and second electric motors 40 and 50 are arranged to extend along the rod-shaped thigh link 11 in the humanoid robot 100 so that the rotating shaft 31, and the rotation shafts of the first and second electric motors 40 and 50 can be orientated to agree their extension directions with each other. For this reason, unlike a case where the rotating shaft 31 and the rotation shafts of the first and the second electric motors 40 and 50 are oriented differently from each other, since no components are required to change movement directions of of the first belt 60 and second belt 70 to wind the first belt 60 and the second belt 70 around the differently oriented shafts, it is possible to prevent an increase in the complexity of the humanoid robot 100.

Also, in this embodiment, as described above, the thigh link 11 as the first link is a rod-shaped part. The rotating shaft 31 of the linear movement mechanism 30 as the driving-force transmitter is arranged along the rod-shaped thigh link 11. The first electric motor 40 and the second electric motor 50 are arranged on one side and another side of the thigh link 11 in a shorter widthwise direction, respectively, as viewed from the side where the rotating shaft 31 is positioned with respect to the rod-shaped thigh link 11, which is the front side. As a result, unlike a case where both the first electric motor 40 and the second electric motor 50 are arranged on the one side or the another side in the shorter widthwise direction, because the first electric motor 40 and the second electric motor 50 are arranged on the one side and the another side of the rod-shaped thigh link 11, respectively, in the shorter widthwise direction, it is possible to prevent the electric motors from being arranged out of balance on either side of the thigh link 11. Consequently, when electric motors are used as driving sources without using both sides of a belt, it is possible to prevent an imbalance during operation of the humanoid robot 100 caused by unbalanced arrangement of the electric motors on either side of the rod-shaped thigh link 11.

Also, in this embodiment, as described above, the first electric motor 40 includes the first electric-motor rotation shaft 41, and is arranged on the one side of the shorter widthwise direction such that the first electric-motor rotation shaft 41 is positioned on the thigh link 11 side, which is the first link side, with respect to the rotating shaft 31 of the linear movement mechanism 30, which is the driving-force transmitter. The second electric motor 50 includes the second electric-motor rotation shaft 51, and is arranged on the another side in the shorter widthwise direction such that the second electric-motor rotation shaft 51 is positioned on the thigh link 11 side with respect to the rotating shaft 31 of the linear movement mechanism 30. As a result, since the first electric-motor rotation shaft 41 of the first electric motor 40 and the second electric-motor rotation shaft 51 of the second electric motor 50 are positioned on the thigh link 11 side with respect to the rotating shaft 31 of the linear movement mechanism 30, which is arranged along the rod-shaped thigh link 11, the linear movement mechanism 30, the first electric motor 40, and the second electric motor 50 can be arranged along the periphery of the thigh link 11. Consequently, when electric motors are used as driving sources without using both sides of a belt, it is possible to prevent an increase in the size of a structure around the periphery of the thigh link 11, and it is possible to prevent an increase in the size of the configuration of the humanoid robot 100.

Also, in this embodiment, as described above, the linear movement mechanism 30, which is the driving-force transmitter, includes the pulley 33 that rotates together with the rotating shaft 31, and around which both the first belt 60 and the second belt 70 are wound. The first belt 60 and the second belt 70 are positioned adjacent to each other in the extension direction of the rotating shaft 31, with an offset relative to each other when wound around the pulley 33. As a result, since the first belt 60 and the second belt 70 are positioned adjacent to each other and wound around the pulley 33, with an offset relative to each other, it is possible to prevent an increase in the size in the extension direction of the rotating shaft 31. Consequently, when electric motors are used as driving sources without using both sides of a belt, it is possible to prevent an increase in the size of the configuration of the humanoid robot 100.

Also, in this embodiment, as described above, the thigh link 11 as the first link and the lower leg link 12 as the second link are rod-shaped parts, and rotate relative to each other to perform bending and stretching motions. The linear movement mechanism 30, which is the driving-force transmitter, is arranged on the side opposite to a direction of rotation in which the thigh link 11 and the lower leg link 12 are rotated relative to each other to perform a bending motion. Here, in a case where the linear movement mechanism 30 is arranged on the inner side in the direction of rotation in which the thigh link and the lower leg link are rotated to perform a bending motion, it is possible that the arrangement of the linear movement mechanism 30 and the arrangement of the first and second electric motors 40 and 50, which are the driving sources of the linear movement mechanism 30, could cause the structure of the linear movement mechanism 30 and the first and second electric motors 40 and 50 as a whole to interfere with the bending motion. In such a case, it can be difficult to increase the angle of rotation when the thigh link 11 and the lower leg link 12 are rotated to perform the bending motion. In contrast, because the linear movement mechanism 30 is arranged on the side opposite to the direction of rotation in which the thigh link 11 and the lower leg link 12 are rotated relative to each other to perform a bending motion in this embodiment, it is possible to increase the angle of rotation when the thigh link and the lower leg link are rotated to perform a bending motion when electric motors are used as driving sources without requiring both sides of a belt.

Also, in this embodiment, as described above, the thigh link 11 as the first link is a component of the thigh 1 in the humanoid robot 100. The lower leg link 12 as the second link is a component of the lower leg 2 in the humanoid robot 100. In addition, the rotating shaft 31 of the linear movement mechanism 30, which is the driving-force transmitter, is arranged along the rod-shaped thigh link 11, which is a component of the thigh 1, to rotate the joint 20, which is the knee joint. Here, when the thighs 1 and the lower legs 2 of the humanoid robot 100 perform bending and stretching motions, they are required to support the weight of the entire humanoid robot 100 while performing the motions, and for this reason, electric motors may be used to provide enough torque necessary for the motions in some cases. From this viewpoint, the first belt 60 and the second belt 70 are separately provided to transmit driving force of the electric motors, which are the first electric motor 40 and the second electric motor 50, so that the electric motors can be effectively used as driving sources when the thighs 1 and the lower legs 2 of the humanoid robot 100 perform bending and stretching motions without requiring both sides of a belt to transmit driving force.

Also, in this embodiment, as described above, the robot joint structure 100a of the humanoid robot 100 includes the encoder 80 detecting a rotational speed of the first electric motor 40, and the controller 90 controlling rotational drive of the first electric motor 40 based on detection signals from the encoder 80. The controller 90 drives the second electric motor 50 to follow the first electric motor 40 by controlling the rotational drive of both the first electric motor 40 and the second electric motor 50 using control signals for the first electric motor 40. Accordingly, when both the first electric motor 40 and the second electric motor 50 are used as electric motors as driving sources without requiring both sides of a belt, rotational drive of the first electric motor 40 and rotational drive of the second electric motor 50 can be precisely synchronized controlling the first and second electric motors by using common control signals.

### [Modified Embodiments]

Note that the embodiment disclosed this time must be considered as illustrative in all points and not restrictive. The scope of the present disclosure is not shown by the above description of the embodiments but by the scope of claims for patent, and all modifications (modified example) within the meaning and scope equivalent to the scope of claims for patent are further included.

For example, while the example in which the joint 20 includes the two links, which are the link 21 and the link 22, has been shown in the aforementioned embodiment, the present disclosure is not limited to this. In the present disclosure, the joint may have no links. For example, as in a robot joint structure according to a modified example shown in FIG. 8, a first link 211, which is the thigh, and a second link 212, which is the lower leg, in a humanoid robot may be directly connected via a joint 220, which is a shaft serving as a rotation axis. In this case, a linear movement mechanism 230 is directly and rotatably connected to the second link 212. The transmission of driving force to the linear movement mechanism 230 is the same as in the aforementioned embodiment. In other words, driving force of the first electric motor 40 and the second electric motor 50 is transmitted to the linear movement mechanism 230 via the first belt 60 and the second belt 70, respectively. Also, the joint may include only one link. Here, the linear movement mechanism 230 is an example of a driving-force transmitter.

Also, while the example in which the robot joint structure 100a rotates the thigh link 11 as the first link of the thigh 1 and the lower leg link 12 as the second link of the lower leg 2 of the leg of the humanoid robot 100 relative to each other has been shown in the aforementioned embodiment, the present disclosure is not limited to this. In the present disclosure, the robot joint structure may rotate the first link and the second link relative to each other in a non-humanoid robot. For example, the first links and the second links may be rotated relative to each other in legs of a four-legged robot. Also, the first links and the second links may be connected to and rotated relative to each other not in the legs of the humanoid robot but by elbow joints of arms.

Also, while the example in which the first electric motor 40 and the second electric motor 50 are arranged on the one side and the another side, respectively, in the shorter widthwise direction of the thigh link 11, which is the rod-shaped first link has been shown in the aforementioned embodiment, the present disclosure is not limited to this. In the present disclosure, both the first electric motor and the second electric motor may be arranged on the one side or the another of the first link in the shorter widthwise direction. In addition to the first electric motor and the second electric motor, a third electric motor may be further provided. In other words, three or more electric motors may be provided.

Also, while the example in which the first electric-motor rotation shaft 41 of the first electric motor 40 and the second electric-motor rotation shaft 51 of the second electric motor 50 are arranged on the thigh link 11 side, which is the first link side, with respect to the rotating shaft 31 of the linear movement mechanism 30, which is the driving-force transmitter, has been shown in the aforementioned embodiment, the present disclosure is not limited to this. In the present disclosure, the first electric-motor rotation shaft of the first electric motor, the second electric-motor rotation shaft of the second electric motor, and the rotating shaft of the driving-force transmitter may be aligned in a straight line extending in a left-to-right direction as viewed in the axial direction.

Also, while the example in which the first belt 60 and the second belt 70 are positioned adjacent to each other and wound around the pulley 33 connected to the rotating shaft 31, with an offset relative to each other, has been shown in the aforementioned embodiment, the present disclosure is not limited to this. In the present disclosure, the first belt and the second belt may be spaced away from each other and wound around the pulley.

Also, while the example in which the linear movement mechanism 30, which is the driving-force transmitter, is arranged on the side opposite to a direction of rotation in which the thigh link 11 as the first link and the lower leg link 12 as the second link are rotated relative to each other to perform a bending motion has been shown in the aforementioned embodiment, the present disclosure is not limited to this. In the present disclosure, the driving-force transmitter may be arranged on the forward side of the direction of rotation in which the first link and the second link are rotated relative to each other to perform the bending motion.

Also, while the example in which rotational drive of both the first electric motor 40 and the second electric motor 50 is controlled by control signals to control the first electric motor 40 based on detection signals from the encoder 80 detecting the rotational speed of the first electric motor 40 has been shown in the aforementioned embodiment, the present disclosure is not limited to this. In the present disclosure, encoders may be provided for both on the first electric motor and the second electric motor, and the second electric motor may be driven to follow the first electric motor by controlling detection signals from the encoder of the second electric motor to follow detection signals from the encoder of the first electric motor.

Also, while the example in which the linear movement mechanism 30 as the driving-force transmitter transmits driving force to rotate the thigh link 11 as the first link and the lower leg link 12 as the second link relative to each other by using linear movement of the linear movement outputter 32 has been shown in the aforementioned embodiment, the present disclosure is not limited to this. In the present disclosure, the driving-force transmitter may be a rotary transmission mechanism instead of the linear motion mechanism including the linear movement outputter. In other words, the driving-force transmitter may cause the first link and the second link to rotate relative to each other by transmitting rotational driving force of the first electric motor and the second electric motor as rotational movement.

Functions of elements disclosed in this specification can be realized by a circuit or processing circuit including a general-purpose processor, a dedicated processor, an integrated circuit, ASIC (Application Specific Integrated Circuits), a conventional circuit and/or combination of them configured or programmed to realize the functions disclosed. A processor is considered a processing circuit or circuits because it contains transistors and other circuitry. In the present disclosure, a circuit, unit, or means is hardware that performs an enumerated function or is hardware programmed to perform an enumerated function. The hardware may be the hardware disclosed herein or any other known hardware that is programmed or configured to perform the enumerated functions. If the hardware is a processor, which is considered a type of circuit, the circuit, means, or unit is a combination of hardware and software, and software is used to configure the hardware and/or processor.

### [Modes ]

The aforementioned exemplary embodiment will be understood as concrete examples of the following modes by those skilled in the art.

### (Mode 1)

A robot joint structure includes a first link and a second link that are connected to each other via a joint; a first electric motor and a second electric motor that serve as driving sources to rotate the first link and the second link relative to each other; a driving-force transmitter that includes a rotating shaft rotated by rotational drive from the first electric motor and the second electric motor, and that rotates the first link and the second link relative to each other in response to rotation of the rotating shaft; a first belt that transmits rotational drive from the first electric motor to the rotating shaft; and a second belt that transmits rotational drive from the second electric motor to the rotating shaft.

### (Mode 2)

In the robot joint structure according to mode 1, the driving-force transmitter includes a linear movement mechanism that includes the rotating shaft and a linear movement outputter moving linearly in response to rotation of the rotating shaft, and that moves the first link and the second link relative to each other by moving the linear movement outputter linearly; the first link and the second link are rod-shaped parts arranged in a predetermined portion of a humanoid robot; the rotating shaft of the driving-force transmitter is arranged along the rod-shaped first link; and rotation axes of the first electric motor and the second electric motor are arranged along the rod-shaped first link.

### (Mode 3)

In the robot joint structure according to mode 1 or 2, the first link is a rod-shaped part; the rotating shaft of the driving-force transmitter is arranged along the rod-shaped first link; and the first electric motor and the second electric motor are arranged on one side and another side of the first link in a shorter widthwise direction, respectively, as viewed from a side where the rotating shaft is positioned with respect to the rod-shaped first link.

### (Mode 4)

In the robot joint structure according to mode 3, the first electric motor includes a first electric-motor rotation shaft, and is arranged on the one side in the shorter widthwise direction such that the first electric-motor rotation shaft is positioned on the first link side with respect to the rotating shaft of the driving-force transmitter; and the second electric motor includes a second electric-motor rotation shaft, and is arranged on the another side in the shorter widthwise direction such that the second electric-motor rotation shaft is positioned on the first link side with respect to the rotating shaft of the driving-force transmitter.

### (Mode 5)

In the robot joint structure according to any of modes 1 to 4, the driving-force transmitter includes a pulley that rotates together with the rotating shaft, and around which both the first belt and the second belt are wound; and the first belt and the second belt are positioned adjacent to each other and wound around the pulley, with an offset relative to each other in an extension direction of the rotating shaft.

### (Mode 6)

In the robot joint structure according to any of modes 1 to 5, the first link and the second link are rod-shaped parts, and rotate relative to each other to perform bending and stretching motions; and the driving-force transmitter is arranged on a side opposite to a direction of rotation in which the first link and the second link are rotated relative to each other to perform a bending motion.

### (Mode 7)

In the robot joint structure according to mode 2, the first link is a thigh in the humanoid robot; the second link is a lower leg in the humanoid robot; and the rotating shaft of the driving-force transmitter is arranged along the rod-shaped first link, which is the thigh, to rotate the joint, which is a knee joint.

### (Mode 8)

In the robot joint structure according to any of modes 1 to 7, an encoder that detects a rotational speed of the first electric motor and a controller that controls rotational drive of the first electric motor based on a detection signal from the encoder are further provided; and the controller drives the second electric motor to follow the first electric motor by controlling rotational drive of both the first electric motor and the second electric motor using a control signal that controls the first electric motor.

### (Mode 9)

A robot includes a first link and a second link that are connected to each other via a joint; a first electric motor and a second electric motor that serve as driving sources to rotate the first link and the second link relative to each other; a driving-force transmitter that includes a rotating shaft rotated by rotational drive from the first electric motor and the second electric motor, and that rotates the first link and the second link relative to each other in response to rotation of the rotating shaft; a first belt that transmits rotational drive from the first electric motor to the rotating shaft; and a second belt that transmits rotational drive from the second electric motor to the rotating shaft.

1. A robot joint structure comprising:
a first link and a second link that are connected to each other via a joint;
a first electric motor and a second electric motor that serve as driving sources to rotate the first link and the second link relative to each other;
a driving-force transmitter that includes a rotating shaft rotated by rotational drive from the first electric motor and the second electric motor, and that rotates the first link and the second link relative to each other in response to rotation of the rotating shaft;
a first belt that transmits rotational drive from the first electric motor to the rotating shaft; and
a second belt that transmits rotational drive from the second electric motor to the rotating shaft.

2. The robot joint structure according to claim 1, wherein
the driving-force transmitter includes a linear movement mechanism that includes the rotating shaft and a linear movement outputter moving linearly in response to rotation of the rotating shaft, and that moves the first link and the second link relative to each other by moving the linear movement outputter linearly;
the first link and the second link are rod-shaped parts arranged in a predetermined portion of a humanoid robot;
the rotating shaft of the driving-force transmitter is arranged along the rod-shaped first link; and
rotation axes of the first electric motor and the second electric motor are arranged along the rod-shaped first link.

3. The robot joint structure according to claim 1, wherein
the first link is a rod-shaped part;
the rotating shaft of the driving-force transmitter is arranged along the rod-shaped first link; and
the first electric motor and the second electric motor are arranged on one side and another side of the first link in a shorter widthwise direction, respectively, as viewed from a side where the rotating shaft is positioned with respect to the rod-shaped first link.

4. The robot joint structure according to claim 3, wherein
the first electric motor includes a first electric-motor rotation shaft, and is arranged on the one side in the shorter widthwise direction such that the first electric-motor rotation shaft is positioned on the first link side with respect to the rotating shaft of the driving-force transmitter; and
the second electric motor includes a second electric-motor rotation shaft, and is arranged on the another side in the shorter widthwise direction such that the second electric-motor rotation shaft is positioned on the first link side with respect to the rotating shaft of the driving-force transmitter.

5. The robot joint structure according to claim 1, wherein
the driving-force transmitter includes a pulley that rotates together with the rotating shaft, and around which both the first belt and the second belt are wound; and
the first belt and the second belt are positioned adjacent to each other and wound around the pulley, with an offset relative to each other in an extension direction of the rotating shaft.

6. The robot joint structure according to claim 1, wherein
the first link and the second link are rod-shaped parts, and rotate relative to each other to perform bending and stretching motions; and
the driving-force transmitter is arranged on a side opposite to a direction of rotation in which the first link and the second link are rotated relative to each other to perform a bending motion.

7. The robot joint structure according to claim 2, wherein
the first link is a thigh in the humanoid robot;
the second link is a lower leg in the humanoid robot; and
the rotating shaft of the driving-force transmitter is arranged along the rod-shaped first link, which is the thigh, to rotate the joint, which is a knee joint.

8. The robot joint structure according to claim 1 further comprising:
an encoder that detects a rotational speed of the first electric motor; and
a controller that controls rotational drive of the first electric motor based on a detection signal from the encoder, wherein
the controller drives the second electric motor to follow the first electric motor by controlling rotational drive of both the first electric motor and the second electric motor using a control signal that controls the first electric motor.

9. A robot comprising:
a first link and a second link that are connected to each other via a joint;
a first electric motor and a second electric motor that serve as driving sources to rotate the first link and the second link relative to each other;
a driving-force transmitter that includes a rotating shaft rotated by rotational drive from the first electric motor and the second electric motor, and that rotates the first link and the second link relative to each other in response to rotation of the rotating shaft;
a first belt that transmits rotational drive from the first electric motor to the rotating shaft; and
a second belt that transmits rotational drive from the second electric motor to the rotating shaft.
